(19) United States
(12) Patent Application Publication
(10) Pub. No.: US 2010/0178410 A1
(43) Pub. Date: Jul. 15, 2010

(54) Edible Foamable Compositions Comprising Clay Particles

(76) Inventors: Michael Piatko, West Seneca, NY (US); Ilya Ilyin, Wayland, MA (US)

Correspondence Address: HODGSON RUSS LLP;THE GUARANTY BUILDING, 140 PEARL STREET, SUITE 100, BUFFALO, NY, 14202-4040, US

(21) Appl. No.: 12/688,434

(22) Filed: Jan. 15, 2010

Related U.S. Application Data
(60) Provisional application No. 61/144,968, filed on Jan. 15, 2009.

(51) Int. Cl. A23L 1/035

(52) U.S. Cl. 426/564

(57) ABSTRACT

An edible foam composition comprising fat(s), emulsifier(s), water and clay particles (such as Hectorite particles). The edible foam composition can be foamed. It is considered that the clay particles stabilize the three-phase emulsion obtained when the composition is whipped.

### CROSS-REFERENCE TO RELATED APPLICATIONS

This application claims priority to U.S. provisional patent application No. 61/144,968, filed Jan. 15, 2009.

### FIELD OF THE INVENTION

The invention is relates generally to the field of edible foaming compositions and in particular to foamable compositions comprising inert solid particles.

### BACKGROUND OF THE INVENTION

One of the requirements for food foams that are used to prepare confectionary creams, marshmallows, ice creams, etc. is foam stability. Thus, it is desirable that attributes such as volume, shape, smooth surface and organoleptic features be retained over a period of time in fresh as well as stored products. Stabilizing foam by utilizing specialized additives (stabilizers) is a well-known method to enhance foam stability. From the standpoint of foam reinforcement, the stabilizers can be subdivided into the following groups: i) substances that enhance the viscosity of the foamed composition (thickeners), for example, glycerin and cellulose derivatives; ii) substances that form colloids in foam films thereby decreasing the drying time for the foam, for example, gelatin, starch, and agar-agar; iii) substances that are polymerized in the volume of the foam, for example, synthetic tars and latexes; iv) substances that produce non-water-soluble, high-dispersion sediments when combined with foam thereby reinforcing foam films and hindering their degradation, for example, salts of heavy metals: iron, copper, barium, and aluminum; and v) finely atomized solid substances, which when uniformly distributed over the surface of gas bubbles, reinforce foam films and strengthen the foam (A. P. Merkin, P. R. Taube. Fragile Miracle.—M.: “Chemistry publishers”, 1983).

Previously, foams have been stabilized by using colloidally dispersed solid particles without surfactants with varying results. Zh. Du, M. P. Bilbao-Montoya et al, Langmuir, 2003, v. 19, p. 3106-3108, describe Silicon earth particles (diameter ˜20 nm) rendered hydrophobic, which were used as foam stabilizers. During foaming, bubbles were generated under the water-gas surface in such a way that a portion of the bubbles were coated with solid particles. However, the percentage of stabilized bubbles was very small B. P. Binks, T. Horozov, Angew. Chem. Int. Ed., 2005, v. 44, p. 3722-3725 describe particles of silicon earth (20-50 nm in size) where the surface of the particles was modified to ensure that the particles have a certain degree of hydrophobicity. The size of the bubbles was approximately 5-50 μm, while the foam is described as being stable in relation to coalescence and diffusion-based gas transfer between the different diameter bubbles. Foams and emulsions stabilized by solid particles are also described in the application WO 2007/068127.

EP1668992A1 describes a food composition comprising water, an emulsion, and solid inert particles that stabilize the foam. Solid particles are used to stabilize a preformed emulsion such as dairy cream.

### BRIEF SUMMARY OF THE INVENTION

The present invention provides an edible foam composition comprising: (a) fat, wherein the fat is present at between 5% and 35% by weight of the composition; (b) emulsifier; (c) water; and (d) clay particles, wherein the clay particles are less than 1% of the total weight of the foam. In one embodiment, the clay particles are less than 25 nm. In another embodiment, the clay particles have an average particle size of less than 1 micron. In another embodiment, the clay particles are hectorite particles.

In one embodiment, the edible foam composition of the present invention is foamable. The foamed compositions are stable for at least 4 days.

### BRIEF DESCRIPTION OF THE DRAWINGS

FIG. 1. (a) Image of rosettes prepared from sample AT02-17. (b) Image of rosettes prepared from sample AT02-17 after 3 hours. (c) Image of rosettes prepared from sample AT02-17 after 20 hours. (d) Image of rosettes prepared from sample AT02-17 after defrosting.

FIG. 2. (a) Image of rosettes prepared from sample AT02-16. (b) Image of rosettes prepared from sample AT02-16 after 3 hours. (c) Image of rosettes prepared from sample AT02-16 after 7 hours. (d) Image of rosettes prepared from sample AT02-16 after defrosting.

FIG. 3. (a) Image of rosettes prepared from sample AT01-61. (b) Image of rosettes prepared from sample AT01-61 after 3 hours. (c) Image of rosettes prepared from sample AT01-61 after 24 hours.

FIG. 4. (a) Image of rosettes prepared from sample AT01-61d. (b) Image of rosettes prepared from sample AT01-61d after 8 hours. (c) Image of rosettes prepared from sample AT01-61d after 24 hours.

FIG. 5. (a) Image of rosettes prepared from sample AT04-006d (0.5% XLG Laponite) (b) Image of rosettes prepared from sample AT04-006d after 1 hour. (c) Image of rosettes prepared from sample AT04-006d after 2 hours. (d) Image of rosettes prepared from sample AT04-006d after 4 hours. (e) Image of rosettes prepared from sample AT04-006d after 6 hours.

FIG. 6. (a) Image of rosettes prepared from sample AT04-007d (0.5% XLS Laponite) (b) Image of rosettes prepared from sample AT04-007d after 1 hour. (c) Image of rosettes prepared from sample AT04-007d after 2 hours. (d) Image of rosettes prepared from sample AT04-007d after 4 hours. (e) Image of rosettes prepared from sample AT04-007d after 6 hours.

FIG. 7. (a) Image of rosettes prepared from sample AT04-009d (0.5% Hectorite) (b) Image of rosettes prepared from sample AT04-009d after 1 hour. (c) Image of rosettes prepared from sample AT04-009d after 2 hours. (d) Image of rosettes prepared from sample AT04-009d after 4 hours. (e) Image of rosettes prepared from sample AT04-009d after 6 hours. (f) Image of rosettes prepared from sample AT04-009d after 24 hours.

FIG. 8. Image of rosettes prepared from sample AT01-010d (Laponite added to ready emulsion).

FIG. 9. Images depicting examples of rosettes with different performance.

FIG. 10. Example of a particle size distribution for formulation containing 24% fat/0.5% Hectorite.

FIG. 11. Example of a particle size distribution for formulation containing 16% fat/0.6% Hectorite.

### DETAILED DESCRIPTION OF THE INVENTION

The present invention provides a foamable food compositions having enhanced stability at ambient temperatures and also exhibiting enhanced stability when mechanical shear forces are applied to the foam.

The foamable food compositions comprise oil, water, emulsifier, and solid clay particles. While not intending to be bound by any particular theory, it is believed that when the composition is whipped, a three-phase emulsion is obtained wherein the oil globules are concentrated at the water/air interface and ensure stability of foam structure.

To obtain a stabilizing effect, the solid particles should be anisotropic. Silicates (such as the class of sheet silicates) can be used in the present invention. For example, hydrous silicates (e.g., phyllosilicates) can be used. In one embodiment, the clay particles comprise montmorillonites. In another embodiment, the clay particles comprise Bentonite or Hectorite. In yet another embodiment, the particles are Laponite® particles. In still another embodiment, the clay particles are a combination of the aforementioned particles.

Added solid particles are preferably at least partly hydrophobic so as to become incorporated into the oil/water interface; however, they should not be too hydrophilic so as not to increase the aqueous phase viscosity and, hence, not change organoleptic features of the product. Such features could be characteristic properties of the particles themselves or the surface of the particles could be modified to make them hydrophobic or hydrophilic, for example, by using certain polymers.

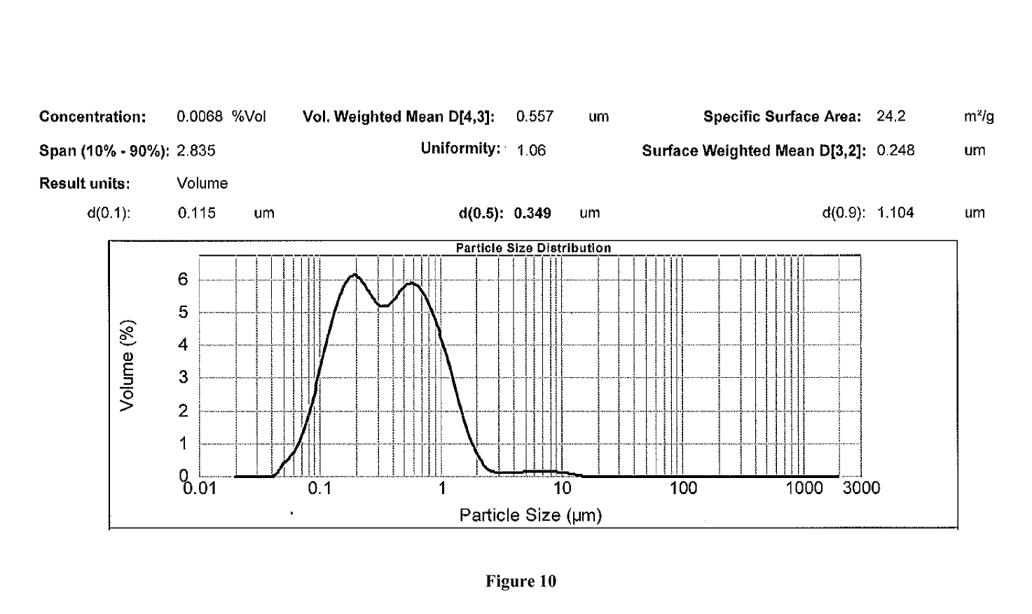

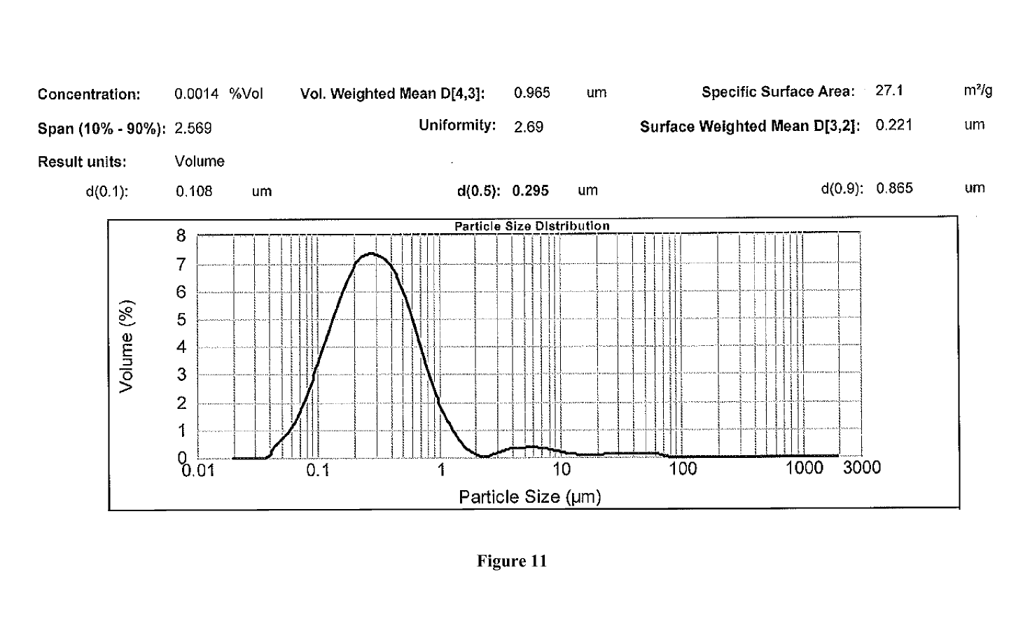

The size of solid particles may vary within the range from 1 nm to several dozens of microns. In one embodiment, the average particle size was <1 μm. In one embodiment, 90% of the particles are less than 1.25 microns and 50% are less than 0.5 microns. Examples of a particle size distribution for formulations containing 24% fat/0.5% Hectorite and 16% fat/0.6% Hectorite is shown in FIGS. 10 and 11 respectively.

The concentration of particles in the whipped foam should preferably be less than 1% of the total foam weight; and more preferably, it should be within the range from 0.3-0.5% of the total foam weight.

When preparing the composition, solid particles should be added in aqueous phase and/or in oil phase of the composition (depending upon the material of the particles). To simplify addition of the Hectorite it can be dispersed into the aqueous phase in advance. The particles are preferably added to the mix prior to formation of the emulsion. Therefore, the particles should be added before the addition of any emulsifiers.

The fat in the composition is between 5%-35% and more preferably between 10%-20%. The fat could be both vegetable or animal origin. Examples of suitable fats include fractionated, interesterified, unhydrogenated, partially or fully hydrogenated: palm, palm kernel, coconut, milkfat, soy, cottonseed, canola , and other vegetable or animal fats or blend of fats thereof.

A wide variety of emulsifiers may be employed in amounts on the same order as in the prior art oil-in-water emulsions. Suitable emulsifiers include lecithin, hydrolyzed lecithin; mono, di, or polyglycerides of fatty acids, such as stearine and palmitin mono and diglycerides, polyoxyethylene ethers of fatty esters of polyhydric alcohols, such as the polyoxyethylene ethers of sorbitan monostearate (Polysorbate 60) or the polyoxyethylene ethers of sorbitan monooleate (Polysorbate 80); fatty esters of polyhydric alcohols such as sorbitan monostearate or tristearate; polyglycerol esters of mono and diglycerides such as hexaglyceryl distearate; mono- and/or diesters of glycols such as propylene glycol monostearate, and propylene glycol monopalmitate, succinoylated monoglycerides. More preferably the class of anionic emulsifiers such as: the esters of carboxylic acids such as lactic, citric, and tartaric acids with the mono- and diglycerides of fatty acids such as glycerol lacto palmitate and glycerol lacto stearate, and calcium or sodium stearoyl lactylates and all members of the sucrose ester family thereof, all varieties of diacetyltartaric esters of fatty acids, “DATEMS”, and the like, and mixtures thereof have been found to perform well with Hectorite and other types of clays.

Data obtained using the present compositions showed that such a composition maintains its integrity for at least 7 days. Additionally, the foam also maintains its integrity during storage for up to 4 days at temperatures up to 30° C. Further, such foams also maintain their integrity upon application of mechanical shear force applied from pastry bag or other types of mechanical dispensers after 8-hour storage at temperature up to 30° C.

### Example 1

This example provides a composition wherein the clay particles were added to the composition after formation of the emulsion. In Sample AT02-16, clay was directly dispersed in emulsion while in Sample AT02-17, clay was dispersed in water and then added to emulsion.

TABLE 1

| | AT samples: wt % | |
|---|---|---|
| | AT02-16 | AT02-17 |
| | Short description | |
| | | Clay dispersed in |
| | Clay added to | H₂O and added to |
| | emulsion after | emulsion after |
| | homogenization | homogenization |
| PALM KERNEL OIL | 16 | 16 |
| POLYALDO HGDS K | 0.1 | 0.1w |
| CASEINATE SODIUM | 1.3 | 1.3 |
| HECTORITE | 0.5 | 0.5 |
| METHOCEL F50 | 0.255 | 0.255 |
| XANTHAN GUM | 0.04 | 0.04 |
| POTASSIUM SORBATE | 0.1 | 0.1 |
| VANILLA FLAVOR | 0.03 | 0.03 |
| SALT REGULAR | 0.14 | 0.14 |
| WATER | 39.25 | 39.25 |
| FRUCTOSE | 19.00 | 19.00 |
| Dextrose | 23.00 | 23.00 |
| SSL | 0.28 | 0.28 |
| TOTALS PERCENT | 100 | 100 |
| Batch size, gm: | 1000 | 1000 |

The formulation AT02-17 was prepared as follows. The premix was dispersed in hot oil with rapid agitation; the mix was heated to 63° C. (145° F.). Water is added to the (oil +premix) with rapid agitation. Then corn syrup and the hydrophilic emulsifier were added to the mix with constant agitation. The mix was pasteurized at 71-77° C. (160-170° F.) for 5 minutes and then homogenize at 2500 psi first stage and 500 psi second stage (total 3000 psi). The mix was then cooled to 100 F for first stage and the between 5-10° C. (40-50° F.) for the final temperature. The mix is tempered at 48° F. for at least for ˜8 hours. The clay was then added directly to the emulsion with rapid agitation after being mixed with water with a high shear mixer before being added to emulsion. After adjusting the product temperature to 48° F. it was whipped in Hobart or Kitchenaide type system or more preferably using a continuous whipping system like an Oakes or Mondo.

The formulation AT02-16 was prepared as follows. The premix was dispersed in HOT oil with rapid agitation and the mix was heated at least 63° C. (145° F.). Water was added to the (oil+premix) with rapid agitation. Then corn syrup and hydrophilic emulsifier were added to the mix with constant agitation. The mix was pasteurized at 71-77° C. (160-170° F.) for 5 minutes, homogenized at 2500 psi first stage and 500 psi second stage (total 3000psi), and cooled to 100 F for first stage and then 5-10° C. (40-50° F.). The emulsion was put in the refrigerator for tempering at least for ˜8 hours. The clay was then added directly to the emulsion with rapid agitation. After adjusting the product temperature to 48° F. it was whipped in Hobart or Kitchenaide type system or more preferably using a continuous whipping system like an Oakes or Mondo.

The results of the bag testing time are presented in the following. For both formulations, the fat was 16% and clay was at 0.5% and with the homogenization pressures set at 500psi for second stage and 2500 psi for first stage.

TABLE 2

| | | Monitored values | | | | | | |
|---|---|---|---|---|---|---|---|---|
| | | | | Bag | | | | |
| | | | | time | | | | |
| | | | | (after | | Viscosity | | Whipping |
| | Clay | % | Bag time | freeze- | Penetrometer | (Speed | | time |
| Formulation # | Introducing | Overrun | (minute) | thaw) | (mm) | 60) | Aw | (sec) |
| AT02-16 | clay added to | 363 | <3 hrs | 0 | 24 | 120 | 0.87 | 740 |
| | emulsion | | | | | | | |
| | after | | | | | | | |
| | homogenization | | | | | | | |
| AT02-17 | clay | 413 | 0 | 0 | 27 | 120 | 0.88 | 1000 |
| | dispersed in | | | | | | | |
| | H₂O and | | | | | | | |
| | added to | | | | | | | |
| | emulsion | | | | | | | |
| | after | | | | | | | |
| | homogenization | | | | | | | |

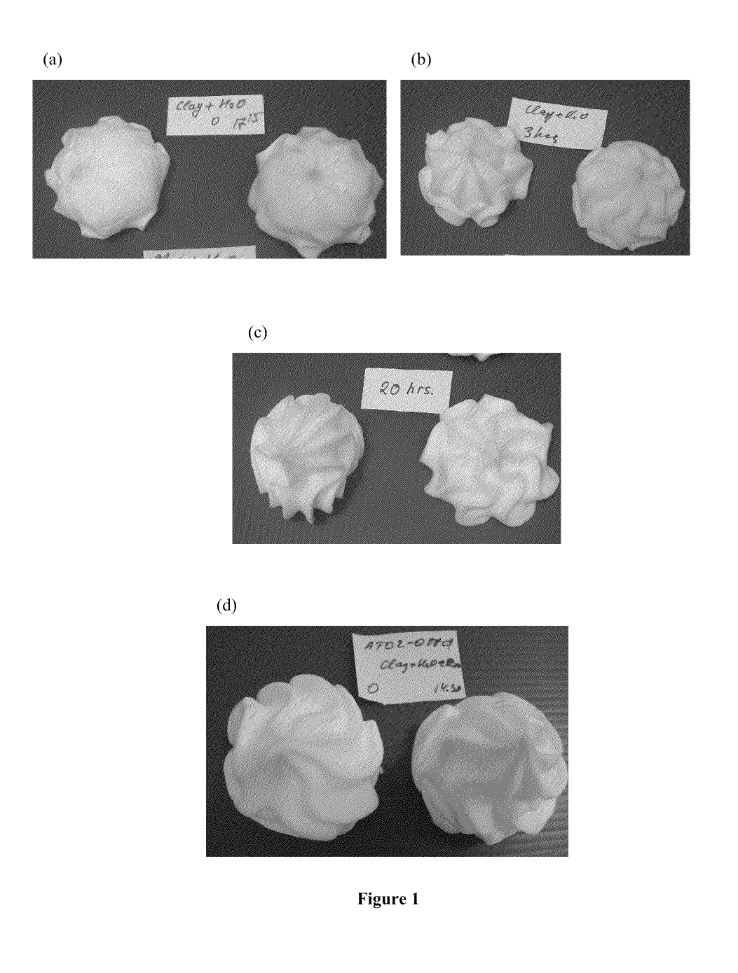

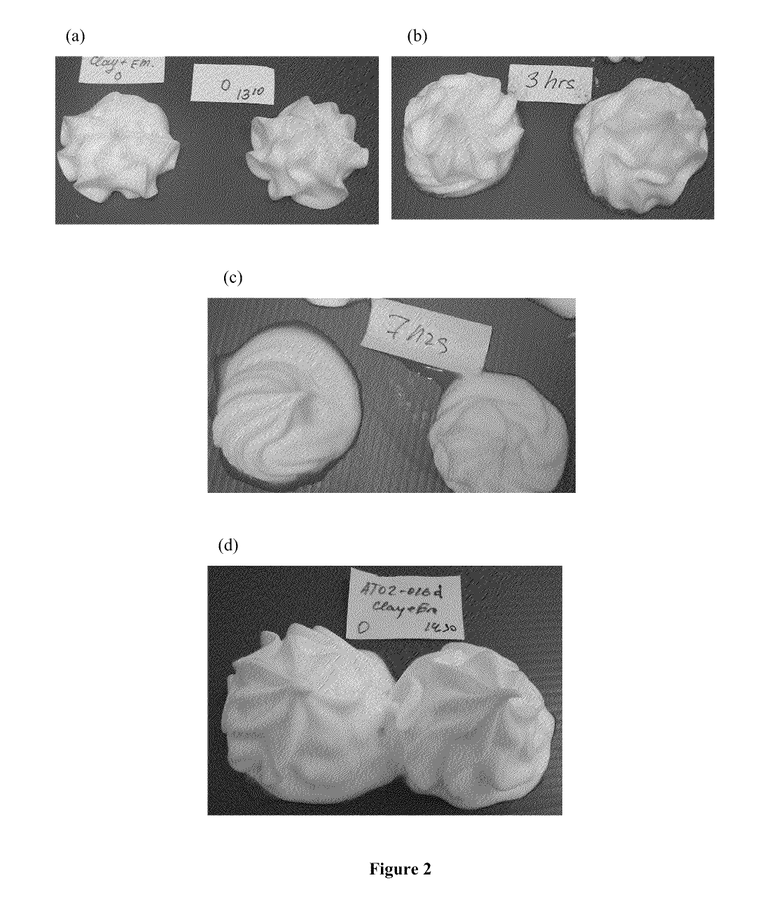

These appearances of the whipped products from these formulations are shown in FIGS. 1 and 2 and indicate that the addition of Hectorite after homogenization results in a soft and wetter product with poor performance characteristics.

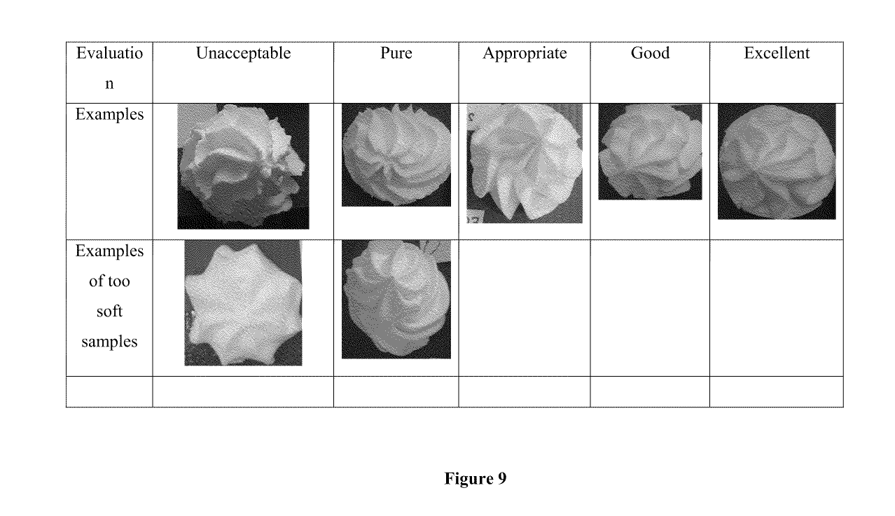

Examples of rosettes with different performance is shown in FIG. 9.

### Example 2

This example describes a composition in which the clay particles were added before formation of the emulsion. The PREMIX was dispersed in HOT oil with rapid agitation and it was heated to at least 63° C. (145° F.). Clay was added to water with high shear mixer and then water containing clay was added to the (oil+premix) with rapid agitation followed by addition of corn syrup and hydrophilic emulsifier with constant agitation. The mix was pasteurized at 71-77° C. (160-170° F.) for 5 minutes and then homogenized at 2500 psi for the first stage and 500 psi for the second stage (total 3000 psi). The mix was cooled to 100 F for first stage and then 5-10° C. (40-50° F.). The emulsion was tempered for at least ˜8 hours and then After adjusting the product temperature to 48° F. it was whipped in Hobart or Kitchenaide type system or more preferably using a continuous whipping system like an Oakes or Mondo.

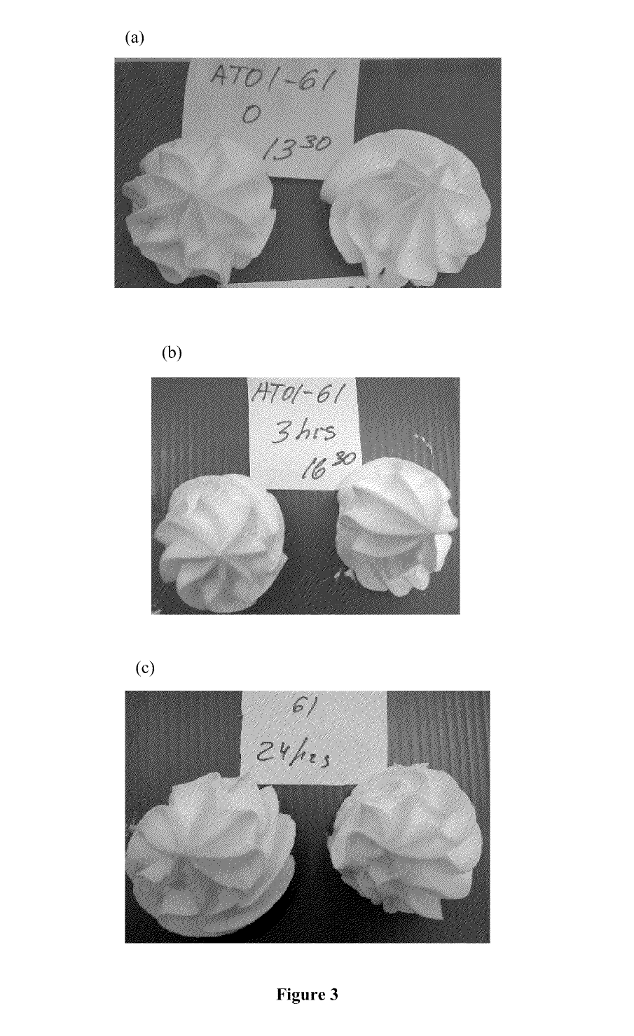

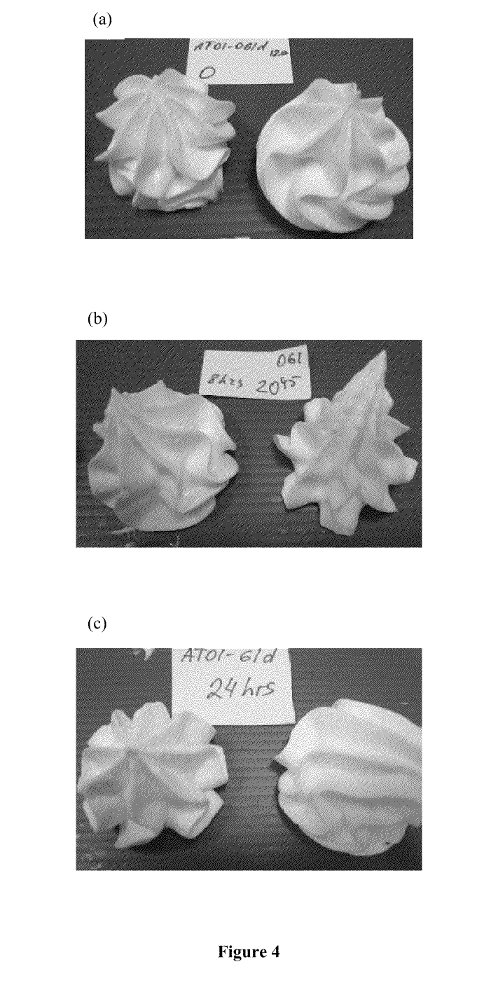

The results are shown in FIG. 3 for a sample containing 16% fat+0.5% clay. Results for the same sample after freezing and defrosting are shown in FIG. 4.

### Example 3

In this example the foam stabilizing ability of Hectorite was compared with that of the synthetic clay Laponite. Hectorite was found to have a greater wetting angle than Laponite XLS or XLG. The compositions compared are shown in Table 3.

Laponite was found to affect taste of cream and emulsion—it added some bitter and constricted/drawn notes. Further, Laponite did not form gel during dispersing in water whereas Hectorite did. Both kinds of Laponite (XLS and XLG) had similar performance characteristics for clay stabilization but were observed to be not as good as Hectorite in the tested ranges 0.1-0.5% using similar methods of preparing. The performance of formulations comprising these clays is shown in Table 4.

All formulations contained 14% fat, 35% dextrose and no fructose.

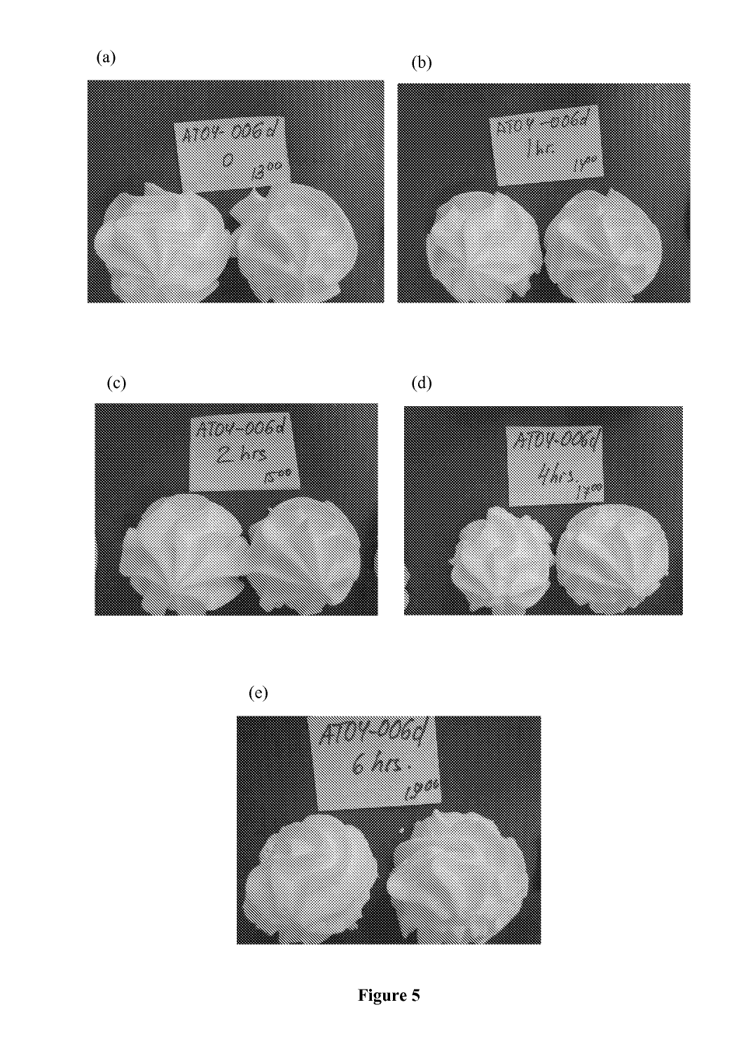

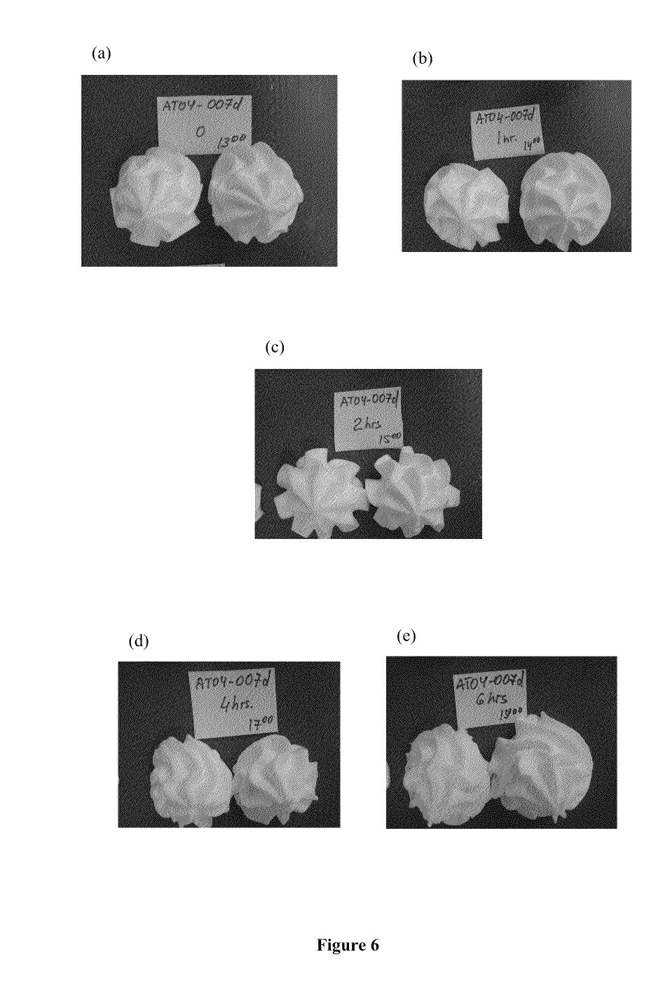

The results for a formulation containing 0.5% Laponite XLG is shown in FIG. 5 and for formulation containing 0.5% Laponite XLS is shown in FIG. 6.

TABLE 3

| | AT samples: wt % | | | | | | |
|---|---|---|---|---|---|---|---|
| | AT04-001 | AT04-002 | AT04-003 | AT04-004 | AT04-005 | AT04-006 | AT04-007 |
| short description | Control | clay | clay Laponite | clay Laponite | clay Laponite | clay Laponite | clay Laponite |
| | w/o | Laponite | XLS | XLG | XLS | XLG | XLS |
| | Laponite | XLG | | | | | |
| PALM KERNEL | 14 | 14 | 14 | 14 | 14 | 14 | 14 |
| OIL | | | | | | | |
| POLYALDO | 0.1 | 0.1 | 0.1 | 0.1 | 0.1 | 0.1 | 0.1 |
| HGDS K | | | | | | | |
| CASEINATE | 1.3 | 1.3 | 1.3 | 1.3 | 1.3 | 1.3 | 1.3 |
| SODIUM | | | | | | | |
| Laponite | 0.0 | 0.1 | 0.1 | 0.3 | 0.3 | 0.5 | 0.5 |
| METHOCEL F50 | 0.255 | 0.255 | 0.255 | 0.255 | 0.255 | 0.255 | 0.255 |
| XANTHAN GUM | 0.04 | 0.04 | 0.04 | 0.04 | 0.04 | 0.04 | 0.04 |
| POTASSIUM | 0.1 | 0.1 | 0.1 | 0.1 | 0.1 | 0.1 | 0.1 |
| SORBATE | | | | | | | |
| VANILLA | 0.03 | 0.03 | 0.03 | 0.03 | 0.03 | 0.03 | 0.03 |
| FLAVOR | | | | | | | |
| SALT REGULAR | 0.14 | 0.14 | 0.14 | 0.14 | 0.14 | 0.14 | 0.14 |
| WATER | 48.75 | 48.65 | 48.65 | 48.45 | 48.45 | 48.25 | 48.25 |
| FRUCTOSE | 0.00 | 0.00 | 0.00 | 0.00 | 0.00 | 0.00 | 0.00 |
| Dextrose | 35.00 | 35.00 | 35.00 | 35.00 | 35.00 | 35.00 | 35.00 |
| SSL | 0.28 | 0.28 | 0.28 | 0.28 | 0.28 | 0.28 | 0.28 |
| TOTALS | 100 | 100 | 100 | 100 | 100 | 100 | 100 |
| PERCENT | | | | | | | |
| Batch size, gm: | 1500 | 1000 | 1000 | 1000 | 1000 | 1000 | 1000 |

For all samples with Laponite, it was added to water with high shear mixer before addition of premix and homogenizer

| | | | | | | | |
|---|---|---|---|---|---|---|---|
| Storage T-Bag | 25 | 25 | 25 | 25 | 25 | 25 | 25 |
| time test | | | | | | | |
| Whipping speed | 12 | 12 | 12 | 12 | 12 | 12 | 12 |

TABLE 4

| | | | | Monitored values | | | | |
|---|---|---|---|---|---|---|---|---|
| | | | | Bag time | | | | |
| | | | | (after | | Viscosity | | Whipping |
| | | | % | freeze- | Penetrometer | (Speed | | time |
| # tests | Clay % | Clay Introdution | Overrun | thaw) | (mm) | 60) | Aw | (sec) |
| AT04-001 | 0 | | 546 | 0 | >36 | 50 | 0.9 | 1000 |
| AT04-002 | 0.1 | For all samples with | 522 | <24 hrs (6-8) | 23 | 185 | 0.89 | 900 |
| | Laponite | Laponite, it was added to | | | | | | |
| | XLG | water with high shear mixer | | | | | | |
| | | before addition of premix | | | | | | |
| | | and homogenizer | | | | | | |
| AT04-003 | 0.1 | | 512 | <24 hrs (6-8) | 24 | 160 | 0.88 | 660 |
| | Laponite | | | | | | | |
| | XLS | | | | | | | |
| AT04-004 | 0.3 | | 455 | 4 hrs | 23 | 320 | 0.88 | 600 |
| | Laponite | | | | | | | |
| | XLG | | | | | | | |
| AT04-005 | 0.3 | | 454 | 4 hrs | 25 | 314 | 0.89 | 600 |
| | Laponite | | | | | | | |
| | XLS | | | | | | | |
| AT04-006 | 0.5 | | 417 | 3-4 hrs | 23 | 1280 | 0.88 | 500 |
| | Laponite | | | | | (speed | | |
| | XLG | | | | | 12) | | |
| AT04-007 | 0.5 | | 410 | 3-4 hrs | 23 | 980 | 0.89 | 500 |
| | Laponite | | | | | (speed | | |
| | XLS | | | | | 12) | | |

### Example 4

This example describes a formulation comprising Hectorite particles.

TABLE 5

| 4 Stage | |
|---|---|
| AT samples: wt % | AT04-009 |
| PALM KERNEL OIL | 14 |
| POLYALDO HGDS K | 0.1 |
| CASEINATE SODIUM | 1.3 |
| HECTORITE | 0.5 |
| METHOCEL F50 | 0.255 |
| XANTHAN GUM | 0.04 |
| POTASSIUM SORBATE | 0.1 |
| VANILLA FLAVOR | 0.03 |
| SALT REGULAR | 0.14 |
| WATER | 48.25 |
| FRUCTOSE | 0.00 |
| Dextrose | 35.00 |
| SSL | 0.28 |
| TOTALS PERCENT | 100 |
| Batch size, gm: | 1000 |

The performance is presented in the table below.

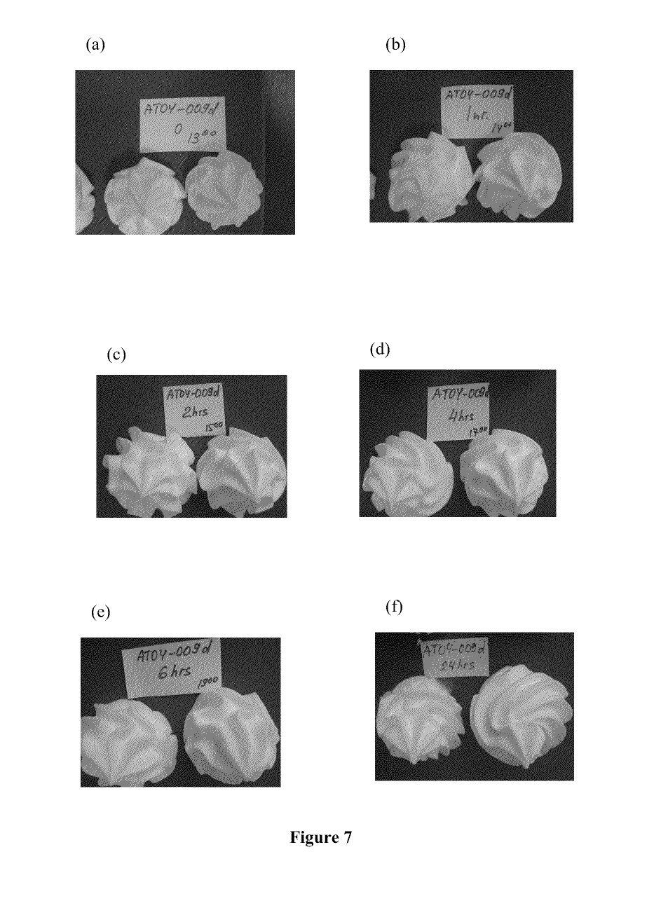

The appearance of this formulation is shown in FIG. 7.

TABLE 6

| | | | Monitored values | | | | | |
|---|---|---|---|---|---|---|---|---|
| | | | | Bag time | | | | |
| | | | | (after | | Viscosity | | Whipping |
| | | Clay | % | freeze- | Penetrometer | (Speed | | time |
| Formulation | Clay % | Introducing | Overrun | thaw) | (mm) | 60) | Aw | (sec) |
| AT04-009 | 0.5 | clay | 415 | −24 hrs | 23.5 | 444 | 0.87 | 420 |
| | | dispersed | | | | | | |
| | | in H₂O | | | | | | |
| | | with high | | | | | | |
| | | shear | | | | | | |
| | | before | | | | | | |
| | | addition of | | | | | | |
| | | premix and | | | | | | |
| | | homogenization | | | | | | |

### Example 5

This example describes a formulation comprising Laponite in which the Laponite particles were added to already formed emulsion. The formulation is shown in the table below.

TABLE 7

| | AT samples: wt % |
|---|---|
| | AT04-010 |
| | short description |
| | add laponite to water - mix and then |
| | add to ready emulsion before whipping |
| PALM KERNEL OIL | 14 |
| POLYALDO HGDS K | 0.1 |
| CASEINATE SODIUM | 1.3 |
| HECTORITE (laponite) | 0.5 |
| METHOCEL F50 | 0.255 |
| XANTHAN GUM | 0.04 |
| POTASSIUM SORBATE | 0.1 |
| VANILLA FLAVOR (Russian) | 0.03 |
| SALT REGULAR | 0.14 |
| WATER | 48.25 |
| FRUCTOSE | 0.00 |
| Dextrose | 35.00 |
| SSL | 0.28 |
| TOTALS PERCENT | 100 |
| Batch size, gm: | 1000 |
| Storage T - Bag time test | 25 |
| Whipping speed | 12 |
| | clay dispersed in H₂O with high |
| | shear before addition of premix |
| | and homogenization |

The performance is shown in the table below. The Laponite was added to water and then the mix of Laponite water was added to ready emulsion before whipping.

TABLE 8

| | | | Monitored values | | | | | |
|---|---|---|---|---|---|---|---|---|
| | | | | Bag | | | | |
| | | | | Time | | | | |
| | | | | (after | | Viscosity | | |
| | | Clay | % | freeze- | Penetrometer | (Speed | | Whipping |
| # tests | Clay % | Introducing | Overrun | thaw) | (mm) | 60) | Aw | time (sec) |
| AT04-010 | 0.5 | laponite | 476 | 0 | 26 | 158 | 0.89 | 720 |
| | laponite | dispersed in | | | | | | |
| | XLG | H₂O and | | | | | | |
| | | added to | | | | | | |
| | | emulsion after | | | | | | |
| | | homogenization | | | | | | |

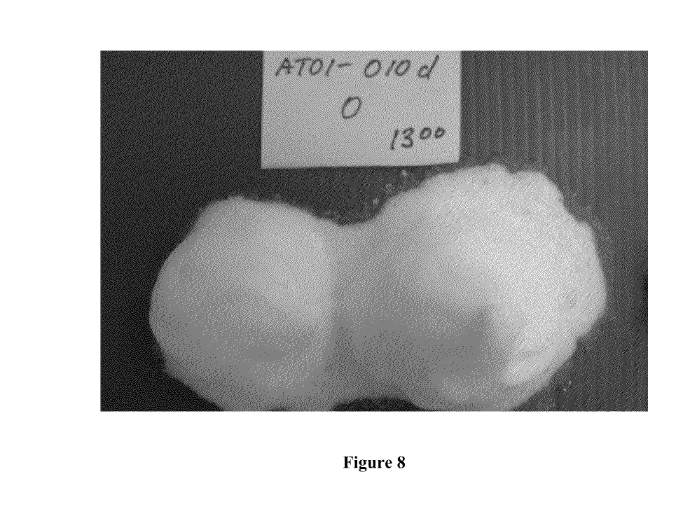

The appearance of the whipped formulation is shown in FIG. 8.

What is claimed is:

1. An edible foam composition comprising:
(a) fat, wherein the fat is present at between 5% and 35% by weight of the composition;
(b) emulsifier;
(c) water; and
(d) clay particles, wherein the clay particles are less than 1% of the total weight of the foam.

2. The edible foam composition of claim 1, wherein the clay particles have an average particle size of less than 1 micron.

3. The edible foam composition of claim 1, wherein the clay particles are Hectorite particles.
